(19) United States
(12) Patent Application Publication
(10) Pub. No.: US 2022/0306495 A1
(43) Pub. Date: Sep. 29, 2022

(54) REDUCTION OF INDUSTRIAL OILY WASTE WATER AND ELIMINATION OF EVAPORATION PONDS

(71) Applicant: Saudi Arabian Oil Company, Dhahran (SA)

(72) Inventor: Mohamed Ahmed Soliman, Ras Tanura (SA)

(73) Assignee: Saudi Arabian Oil Company, Dhahran (SA)

(21) Appl. No.: 17/205,315

(22) Filed: Mar. 18, 2021

(51) Int. Cl. C02F 1/44; C02F 1/58; C02F 1/68; C02F 1/00

(52) U.S. Cl. CPC C02F 1/445; C02F 1/58; C02F 1/68; C02F 1/001; C02F 2101/32

(57) ABSTRACT

A method to reduce the generation of waste water comprising the steps of withdrawing a formation water stream from production equipment; introducing the formation water stream to a forward osmosis unit, where the forward osmosis unit comprises a semipermeable membrane, where the formation water stream is introduced to a draw side of the semipermeable membrane; withdrawing a surface water feed from a waste water collection pit, the surface water feed comprises water and contaminants; introducing the surface water feed to the forward osmosis unit, where the surface water feed is introduced to a feed side of the semipermeable membrane; separating the water in the surface water feed through the semipermeable membrane, where the water travels from the feed side to the draw side due to osmotic pressure; withdrawing a diluted stream from the draw side of the semipermeable membrane; and introducing the diluted stream to a water-oil separation plant.

### TECHNICAL FIELD

Disclosed are systems and methods for treating oily water. More specifically, disclosed are systems and methods for treating oily water collected at the surface of the oil recovery plant and minimizing the environmental pollution from the evaporation ponds.

### DESCRIPTION OF THE RELATED ART

In general, the gas oil separation plant (GOSP) is a continuous separation process that normally includes a high-pressure production trap (HPPT), a low-pressure production trap (LPPT), a low pressure degasing tanks (LPDT), a dehydrator unit, first and second stage desalting units, a water-oil separation plant, a stabilizer column, pumps, heat exchangers, and reboilers.

The purpose of a Gas-Oil Separation Plant (GOSP) is to remove the high salinity produced water, salt, and hydrocarbon gasses from the wet crude and meet the export crude specifications. Produced water is water that is recovered as a byproduct along with crude oil or gas, especially water brought to the surface in an oil or gas recovery process. This produced water is usually a high salinity water that even with treatment must be disposed in underground formations to protect the environment from pollutants. Typically, in the GOSP, the pressure is often reduced in several stages to allow the controlled separation of volatile components. The idea is to achieve maximum liquid recovery, along with stabilized oil and gas, and to separate water. The majority of the water is normally separated in the dehydrator and desalters, the wet crude tanks and the production traps. The water-oil separation plant is designed to collect the streams of produced water from the dehydrators, LPPT, LPDT, and HPPT, and to separate oil from the collected water. The separated water is discharged for use in water injection wells to enhance crude oil recovery.

Additionally, at the plant, a water collection system uses catch basins, manholes, underground piping, and gravity sewer sumps to collect storm water, firewater, and normal oily water. This collected water can contain pollutants, including hazardous substances, that will pollute the ground water table if leaked. The water is gravity drained to the gravity sewer sumps. The equipment associated with oil recovery with the potential for leakage or spills of said oil is kerbed locally for containment prior to discharge to the gravity sewer. This contaminated oily wastewater from the various plant areas is also routed to the gravity sewer sump. In the gravity sewer sump, oil is separated and then sent to an oil recovery tank to remove oil, which can then be pumped to the low-pressure degassing tank. The de-oiled water in the gravity sewer sump is pumped to the evaporation ponds to evaporate the water.

In this conventional system, the sources for accidental pollution include both the underground sumps and evaporation ponds. Pollution in surrounding groundwater and land can be due to rainfall overflowing the containment systems or due to failure of the containment systems. Soil remediation is resource intensive.

### SUMMARY

Disclosed are systems and methods for treating oily water. More specifically, disclosed are systems and methods for treating oily water collected at the surface of the oil recovery plant and minimizing the environmental pollution from the evaporation ponds.

In a first aspect, a method to reduce the generation of waste water is provided. The method includes the steps of withdrawing a formation water stream from production equipment, where the formation water stream is continuous, introducing the formation water stream to a forward osmosis unit, where the forward osmosis unit includes a semipermeable membrane, where the formation water stream is introduced to a draw side of the semipermeable membrane, withdrawing a surface water feed from a waste water collection pit, where the surface water feed includes water and contaminants, where the contaminants are selected from the group consisting of oil, hazardous substances, dissolved solids, bacteria, and combinations of the same, introducing the surface water feed to the forward osmosis unit, where the surface water feed is introduced to a feed side of the semipermeable membrane, where the semipermeable membrane is configured to allow water to pass through and to prevent the contaminants from passing through, separating the water in the surface water feed through the semipermeable membrane, where the water travels from the feed side to the draw side due to osmotic pressure, withdrawing a diluted stream from the draw side of the semipermeable membrane, and introducing the diluted stream to a water-oil separation plant.

In certain aspects, the method further includes the steps of withdrawing a reject water stream from the feed side of the semipermeable membrane, mixing an oxygen scavenger stream with the reject water stream in an oxygen mixer to produce an oxygen-free stream, where the oxygen scavenger stream includes an oxygen scavenger, mixing the oxygen-free stream with a chemical biocide stream in a biocide mixer to produce a treated reject water stream, where the chemical biocide stream includes a chemical biocide selected from chlorine, glutaraldehyde, tetrakis-hydroxymethyl-phosphonium (THPS), formaldehyde, acrolein, and combinations of the same, and introducing the treated reject water stream to the water-oil separation plant. In certain aspects, the method further includes the steps of introducing the surface water stream to a filter, where the filter is configured to remove dissolved solids in the surface water stream, filtering the surface water stream in the filter to produce a filtered stream, and introducing the filtered stream to the forward osmosis unit. In certain aspects, the method further includes the steps of withdrawing a reject water stream from the feed side of the semipermeable membrane, and introducing the reject water stream to evaporation ponds. In certain aspects, the method further includes the steps of withdrawing an oil-containing water stream from the feed side of the semipermeable membrane, where the oil-containing water stream comprises greater than 100 ppmw, introducing the oil-containing water stream to a hydrocyclone to produce a reject water stream, where the hydrocyclone is configured to separate oil from water, mixing an oxygen scavenger stream with the reject water stream in an oxygen mixer to produce an oxygen-free stream, mixing the oxygen-free stream with a chemical biocide stream in a biocide mixer to produce a treated reject water stream, and introducing the treated reject water stream to an evaporation pond. In certain aspects, the production equipment is selected from the combination of production traps, crude tanks, desalters, and combinations of the same. In certain aspects, the formation water stream has a salinity in the range of 50,000 parts-per-million by weight (ppmw) to 370,000 ppmw. In certain aspects, the semipermeable membrane is selected from a flat membrane, a spiral wound membrane, and a tubular membrane. In certain aspects, the construction of semipermeable membrane is selected from the group consisting of organic materials, mineral or ceramic membranes, and combinations of the same. In certain aspects, the method further includes the steps of separating the diluted stream in the water-oil separation plant to produce a treated produced water and recovered oil, and injecting the treated produced water into a reservoir to maintain a pressure in the reservoir to facilitate producing hydrocarbons.

In a second aspect, a system to reduce the generation of waste water is provided. The system includes production equipment configured to produce a formation water stream such that the formation water stream is continuously withdrawn from the production equipment, a waste water collection pit configured to produce a surface water feed, where the surface water feed includes water and contaminants, where the contaminants are selected from the group consisting of oil, hazardous substances, dissolved solids, bacteria, and combinations of the same, a forward osmosis unit fluidly connected to the production equipment and the waste water collection pit, where the forward osmosis unit includes a semipermeable membrane, where the formation water stream is introduced to a draw side of the semipermeable membrane, where the surface water feed is introduced to a feed side of the semipermeable membrane, where the semipermeable membrane is configured to allow water to pass through and to prevent the contaminants from passing through, where water in the surface water feed travels from the feed side to the draw side due to osmotic pressure, and a water-oil separation plant fluidly connected to the forward osmosis unit, where a diluted stream from the draw side of the semipermeable membrane of the forward osmosis unit is withdrawn and introduced to the water-oil separation plant.

In certain aspects, the system further includes an oxygen mixer fluidly connected to the feed side of the semipermeable membrane, the oxygen mixer configured to mix a reject water stream from the feed side of the semipermeable membrane with an oxygen scavenger stream to produce an oxygen-free stream, where the oxygen scavenger stream includes an oxygen scavenger, and a biocide mixer fluidly connected to the oxygen mixer, the biocide mixer configured to mix the oxygen-free water stream with a chemical biocide stream to produce a treated reject water stream, where the chemical biocide stream includes a chemical biocide selected from chlorine, glutaraldehyde, tetrakis-hydroxymethyl-phosphonium (THPS), formaldehyde, acrolein, and combinations of the same, where the treated reject water stream is introduced to the water-oil separation plant. In certain aspects, the system further includes a filter fluidly connected to the waste water collection pit, the filter configured to remove dissolved solids in the surface water stream to produce a filtered stream, where the filtered stream is introduced to the forward osmosis unit. In certain aspects, the system further includes evaporation ponds fluidly connected to the feed side of the semipermeable membrane, where the reject water stream is introduced to the evaporation ponds. In certain aspects, the system further includes a hydrocyclone fluidly connected to the feed side of the semipermeable membrane, the hydrocyclone is configured to separate oil from water to produce a reject water stream, an oxygen mixer fluidly connected to the hydrocyclone, a biocide mixer fluidly connected to the oxygen mixer, and an evaporation pond fluidly connected to the biocide mixer, where a treated reject stream is introduced to the evaporation ponds.

A method to reduce the generation of waste water, the method includes the steps of withdrawing a surface water feed from a waste water collection pit, where the surface water feed includes water and contaminants, where the contaminants are selected from the group consisting of oil, hazardous substances, dissolved solids, bacteria, and combinations of the same, introducing the surface water stream to a filter, where the filter is configured to remove dissolved solids in the surface water stream, filtering the surface water stream in the filter to produce a filtered stream, introducing the filtered stream to an oxygen mixer, mixing an oxygen scavenger stream with the filtered stream in the oxygen mixer to produce an oxygen-free filtered stream, where the oxygen scavenger stream includes an oxygen scavenger, introducing the oxygen-free filtered stream to a biocide mixer, mixing the oxygen-free filtered stream with a chemical biocide stream to produce a treated stream, where the chemical biocide stream includes a chemical biocide selected from chlorine, glutaraldehyde, tetrakis-hydroxymethyl-phosphonium (THPS), formaldehyde, acrolein, and combinations of the same, and introducing the treated stream to a water-oil separation plant, the water-oil separation plant configured to separate oil from the treated stream.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a process flow diagram of an embodiment of the waste water reduction system.

FIG. 2 is a process flow diagram of an embodiment of the waste water reduction system.

FIG. 3 is a process flow diagram of an embodiment of the waste water reduction system.

FIG. 4 is a process flow diagram of an embodiment of the waste water reduction system.

FIG. 5 is a process flow diagram of an embodiment of the waste water reduction system.

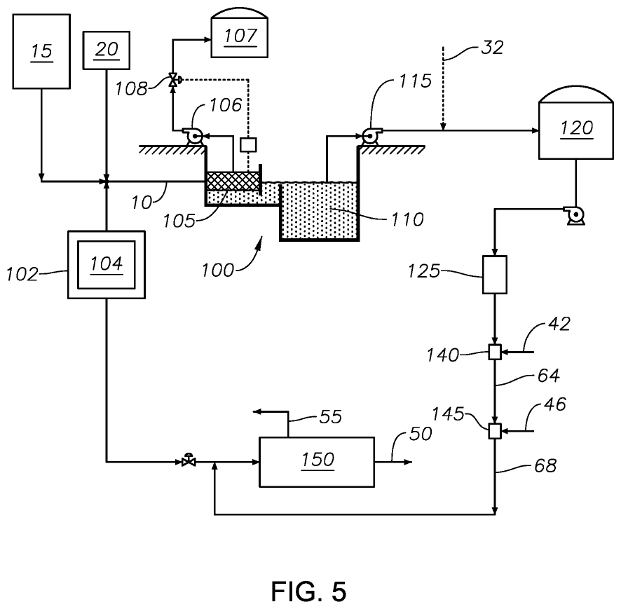

FIG. 6 is a process flow diagram of an embodiment of the waste water reduction system.

FIG. 7 is a process flow diagram of an embodiment of the waste water reduction system.

In the figures, similar components or features, or both, can have the same or similar reference label.

### DETAILED DESCRIPTION OF THE INVENTION

While methods and systems will be described with several embodiments, it is understood that one of ordinary skill in the relevant art will appreciate that many examples, variations and alterations to the systems and methods described here are within the scope and spirit of the embodiments. Accordingly, the embodiments described herein are set forth without any loss of generality, and without imposing limitations, on the embodiments.

The systems and methods of the waste water reduction system can treat oily water and reduce the amount of waste water being diverted to evaporation ponds. The systems and methods of the waste water reduction system can treat oily water using forward osmosis technology, by direct chemical treatment, oxygen scavenging, solids separation, or combinations of the same. The separated water can be reinjected into disposal wells or for use in the oil recovery process. The systems and methods of the waste water reduction system can use the high salinity formation water as a draw solution to extract water from the surface waste water collection system in a forward osmosis unit. The formation water has a high osmotic pressure to extract and concentrate the surface oily waste water.

Advantageously, the waste water reduction system can minimize or eliminate environmental pollution and contamination of the water table or surrounding soil from the evaporation ponds, whether by leaking or release. Advantageously, the waste water reduction system can prevent environmental pollution and the high cost of soil remediation. Advantageously, the waste water reduction system can reduce the generation of waste water, recover waste water, and recycle and reuse waste water. Advantageously, the waste water reduction system can reduce the load on the surface collection system and evaporation ponds, minimize environmental pollution and provide water to meet the requirements for water injection to maintain reservoir pressure. Advantageously, the waste water reduction system can avoid contamination of the ground water table, avoid potential fire as a result of the exposure of hydrocarbons to the environment, recover waste oil, reduce environmental pollution, dispose of oily water from oil facilities, and minimize capital cost by reducing the size of evaporation ponds and waste water treatment. Advantageously, forward osmosis has high water flux, low energy requirements, high salt rejection and low membrane fouling when compared to conventional reverse osmosis processes.

As used throughout, “dike” refers to an embankment or curb built around a piece of equipment and designed to capture and contain any fluids from the interior of the equipment should the piece of equipment be breached.

As used throughout, “formation water” refers to the water produced along with oil or gas.

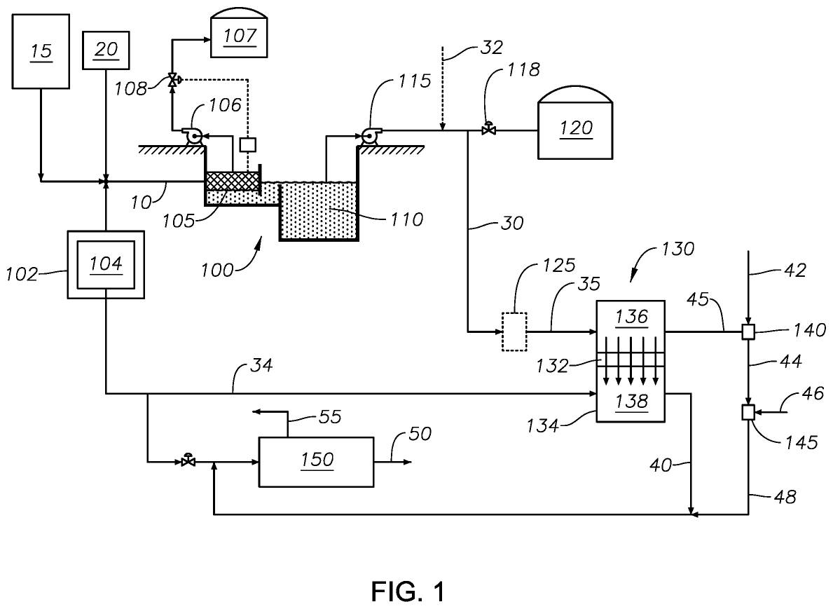

Waste water reduction system 1 can be understood with reference to FIG. 1. Gravity sewer sump 100 collects surface water 10. Gravity sewer sump 100 can include oil separation section 105 and waste water collection pit 110. Gravity sewer sump 100 is located below grade. The surface water 10 is collected through an oily water system that can use catch basins, manholes, underground piping, and sumps to collect storm water, firewater, and oily water flows associated with the equipment at the site. Sources of surface water 10 can include rainfall 15, equipment open drain stream 20, dike stream 25, and combinations of the same. Rainfall 15 can include all precipitation that falls on the site and that is channeled into open drains as run off. Equipment open drain stream 20 can include water, including condensation, collected from process equipment on the site. Process equipment can include heat transfer equipment, pumping systems, towers, sampling stations, and all other equipment and piping. One of skill in the art will understand that sites with process equipment design the system to collect all water produced intentionally or unintentionally from such equipment. Dike stream 25 can include all water collected in dikes 102 surrounding production equipment 104. Production equipment 104 can include production traps, crude oil tanks, desalters, and any other equipment used to store produced oil or formation water. One of skill in the art understands that equipment open drain stream 20 and dike stream 25 can include water collected as a result of precipitation and run off. The system can be designed such that surface rainfall 15, equipment open drain stream 20, and dike stream 25 flow by gravity to surface water 10 and into gravity sewer sump 100. Alternately, pumps can be installed throughout the oily water system to channel rainfall 15, equipment open drain stream 20, and dike stream 25 convey surface water 10 to gravity sewer sump 100.

Surface water 10 can include water, oil, hazardous substances, solids, bacteria, and combinations of the same. The hazardous substances can include hydrogen sulfide, benzene, toluene, xylene, and combinations of the same. The solids can include salts, gravel, organic material, sand, and combinations of the same.

In gravity sewer sump 100, oil in surface water 10 can be separated from water in oil separation section 105. Oil separation section 105 relies on gravity and the different densities of oil and water to produce a separated oil layer floating on top of a water layer. The separated oil layer contains separated oil that can be pumped through oil pump 106 to low pressure de-gassing tank 107 and then further processed as desired. In oil separation section 105, between 70 percent by volume (vol %) and 90 vol % of the oil in surface water 10 can be separated from the water. The level of the separated oil layer in oil separation section 105 can be controlled by control valve 108.

Waste water collection pit 110 collects dirty water from oil separation section 105. The dirty water in waste water collection pit 110 can include the water remaining after oil is separated in oil separation section 105. The dirty water in waste water collection pit 110 contains water, contaminants, and combinations of the same. The contaminants can include oil, hazardous substances, solids, bacteria, and combinations of the same.

Surface water feed 30 can be withdrawn through sump pump 115. Surface oily water tank 120 can be fluidly connected to waste water collection pit 110 and used as a buffer tank to store excess dirty water from waste water collection pit 110 and, optionally, additional gravity sewer sumps. Flow to surface oily water tank 120 can be controlled by valve 118. The addition of surface oily water tank 120 can absorb fluctuations in flow rate to and from waste water collection pit 110, such as due to significant rain events. In additionally, surface oily water tank 120 can stabilize the process. If the site contains more than one gravity sewer sump, additional dirty water 32 from the additional gravity sewer sumps can be mixed with the flow from sump pump 115 as part of surface water feed 30.

Optionally, surface water feed 30 can be introduced to filter 125. Filter 125 can be any filter capable of removing the solids suspended in water. The solids suspended in surface water feed 30 are separated in filter 125 leaving filtered water 35. In at least one embodiment, filter 125 includes a walnut shell fiber filter.

Surface water feed 30, containing contaminants, is introduced to forward osmosis unit 130. Due to the contaminants, surface water feed 30 can have a salinity between 500 ppmw and 10,000 ppmw. The salinity of surface water feed 30 can depend on the amount of rain, the wash water utilized, and the drained oil. Forward osmosis unit 130 can be any type of separation unit that operates on the principles of osmotic pressure. Osmotic pressure is the minimum pressure which needs to be applied to a solution to prevent the inward flow of its pure solvent across a semipermeable membrane. Thus, forward osmosis is a process by which a solvent moves across a semipermeable membrane due to the difference in the solute concentration established across the membrane. For an ideal solution, the relationship between the osmotic pressure of a solution and the molar concentration of its ions is:

π=CRT (1)

where, π is the osmotic pressure, C is the molar concentration of the ions in the solution in mol/liter, R is the universal gas constant (0.08206 L atm mol-1 K−1), and T is temperature on the Kelvin scale.

For example, the following table provides the osmotic pressure for produced or formation water.

| | Produced Water | Sea Water |
|---|---|---|
| Total Dissolved | 125,000-280,000 | 35,000-55,000 |
| Solid, ppmw | | |
| Osmotic Pressure | 1,700-4,100 at 170° F. | 420-670 at 100° F. |
| ranges, psig | (115.5 bar-279 bar at | (28.6 bar-45.6 bar at |
| | 77° C.) | 37.7° C.) |

Water transport through a membrane, or flux, is a function of differential pressure and can be stated as:

Jw=KW(ΔP−Δπ) (2)

where JW is the rate of water passage through the membrane, KW is the permeability coefficient for water for a particular membrane (thus taking into account area and thickness), ΔP is the hydraulic pressure differential, and Δπ is the osmotic pressure differential.

In forward osmosis, the water in a low-concentration solution (low osmotic pressure) permeates and moves through the semipermeable membrane toward a high-concentration solution (high osmotic pressure).

Forward osmosis unit 130 includes semipermeable membrane 132 installed within housing 134. Forward osmosis unit 130 can consist of one housing and one semipermeable membrane or can be include a plurality of housing, each with a semipermeable membrane. In embodiments where forward osmosis unit 130 includes a plurality of housings, the housings can be arranged in series or in parallel. The semipermeable membrane is characterized by having small pores such that water molecules can pass freely, while the passage of solute molecules is hindered or stopped, such that the solute molecules do not pass through. The semipermeable membrane of forward osmosis unit 130 can be selected from a flat membrane, a spiral wound membrane, a tubular membrane, and combinations of the same. The tubular membrane can have a cross section selected from circular, square, rectangular, and triangular. The tubular membrane can include hollow membranes. In at least one embodiment, the semipermeable membrane is a spiral wound membrane. In at least one embodiment, the semipermeable membrane is a tubular membrane containing hollow fibers. The semipermeable membrane can be constructed from organic materials or mineral or ceramic materials. Organic materials can include cellulose acetate, cellulose nitrate, polysulfone, polyvinylidene fluoride, polyamide and acrylonitrile copolymers. Mineral or ceramic materials can include C—Al—O, ZrO, TiO2 or a mixed oxide of SiO, and Al—O or ZrO2. The semipermeable membranes can be composites of organic materials and mineral or ceramic materials. The semipermeable membranes can be designed for the specific application, in light of the solids and other contaminants in the water. The semipermeable membrane can include a feed side and a draw side.

Surface water feed 30 can be introduced to forward osmosis unit 130 on feed side 136 of semipermeable membrane 132. Surface water feed 30 is the low-concentration solution. Semipermeable membrane 132 is configured to prevent the contaminants from passing through whilst allowing the water from the low-concentration solution, surface water feed 30, to pass across. Formation water stream 34 is introduced to draw side 138 of semipermeable membrane 132 in forward osmosis unit 130.

Formation water stream 34 is withdrawn from production equipment 104 and contains the formation water. Formation water stream 34 is in the absence of added components, such that no external materials are mixed with the formation water after the formation water is produced from the formation. In at least one embodiment, the formation water stream is in the absence of added ammonia, carbon dioxide, sulfur dioxide, ammonium bicarbonate, potassium nitrate, magnesium sulfate, magnetoferritin, sucrose, glucose, fructose, and combinations of the same, whether in liquid or aqueous form. Formation water stream 34 can be withdrawn from production equipment 104 as either a continuous stream or an intermittent stream. Whether formation water stream 34 is a continuous stream or intermittent stream depends on the rate of water separation in production equipment 104. The flow rate of formation water stream 34 is split between water-oil separation plant (WOSEP) 150 and forward osmosis unit 130. In at least one embodiment, the flow rate to forward osmosis unit 130 is less than the flow rate to WOSEP 150.

Formation water stream 34 is the high-concentration solution. Formation water stream 34 can have a salinity in the range between 50,000 to 370,000 parts-per million (ppm) by weight.

In forward osmosis unit 130, water from surface water feed 30 can permeate the semipermeable membrane and dilute formation water stream 34 to produce diluted stream 40. The volume of surface water feed 30 can be reduced by at most 90 volume percent (vol %), alternately less than 90 vol %, alternately between 50 vol % and 90 vol %, alternately between 60 vol % and 90 vol %, alternately between 70 vol % and 90 vol %, and alternately between 80 vol % and 90 vol %. The volume reduction of surface water feed 30 can depend on the salinity of formation water stream 34 and the salinity of surface water feed 30. Diluted stream 40 can be returned to WOSEP 150. Forward osmosis unit 130 can operate at temperatures between 60° F. and 115° F. Forward osmosis unit 130 can operate at pressures between 1 psig (1.08 bar) and 500 psig (35.5 bar) on both sides of the semipermeable membrane.

The water and contaminants remaining on the feed side of the semipermeable membrane can be withdrawn from forward osmosis unit 130 as reject water stream 45. Reject water stream 45 contains the contaminants from surface water feed 30 and the water that did not permeate the semipermeable membrane. Reject water stream 45 can further include oxygen.

Reject water stream 45 can be mixed with oxygen scavenger stream 42 in oxygen mixer 140. Oxygen scavenger stream 42 can contain any oxygen scavenger suitable for use in a water stream. Examples of oxygen scavengers suitable for use include sodium bisulfite, hydrazine, carbohydrazide-containing scavengers, and combinations of the same. The oxygen scavenger can remove oxygen from reject water stream 45. Reject water stream 45 and oxygen scavenger 42 are mixed in oxygen mixer 140 to produce oxygen-free stream 44.

Oxygen-free stream 44 can be mixed with chemical biocide stream 46 in biocide mixer 145. Chemical biocide stream 46 can contain any chemical biocide suitable for use in a water stream. Examples of the chemical biocide suitable for use include chlorine, glutaraldehyde, tetrakis-hydroxymethyl-phosphonium sulfate (THPS), formaldehyde, acrolein, and combinations of the same. The chemical biocide can kill any bacteria present in the oxygen-free water stream. Oxygen-free stream 44 and chemical biocide stream 46 can be mixed in biocide mixer 145 to produce treated reject water stream 48. Treated reject water stream 48 can be introduced to WOSEP 150. In at least one embodiment, treated reject water stream 48 can be mixed with diluted stream 40 before being introduced to WOSEP 150.

WOSEP 150 can be any type of separation unit capable of separation oil and water. The WOSEP can include a water-oil separator, pumps, valves, and other instrumentation and units. WOSEP produces treated produced water 50 and recovered oil 55.

Treated produced water 50 can be used in hydrocarbon recovery operations or can be disposed. In at least one embodiment, in the process and system as described with reference to FIG. 1, treated produced water 50 can be injected into a subsurface disposal well. In at least one embodiment, treated produced water 50 can be used as water for power water injection for maintenance of reservoir pressure. In the process and system as described with reference to FIG. 1, all of the water collected in waste water collection pit 110 is recycled and treated in WOSEP 150 and there is no liquid discharged to atmosphere. In the process and system as described with reference to FIG. 1, evaporation ponds can be eliminated from the waste water reduction system 1.

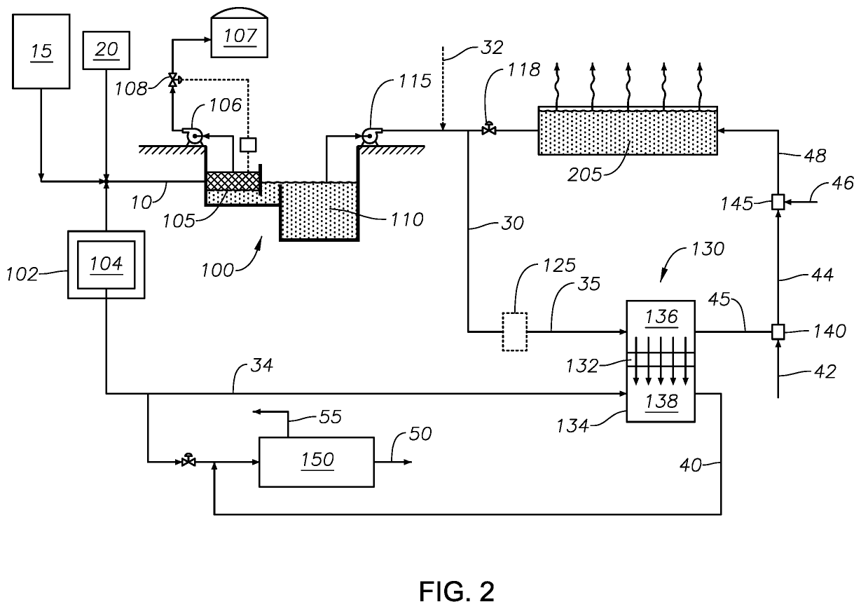

An alternate embodiment of waste water reduction system 1 and associated methods can be understood with reference to FIG. 2 and the description of FIG. 1. Reject water stream 45 can be introduced directly to evaporation ponds 205. Evaporation ponds 205 are configured to allow the water in reject water stream 45 to evaporate into the atmosphere. Advantageously, the waste water reduction system 1 and associated methods described with reference to FIG. 2 can include evaporation ponds smaller than in a system in the absence of a forward osmosis unit. Advantageously, the addition of the forward osmosis unit can minimize or eliminate the overflow from the evaporation ponds, which can reduce or eliminate environmental pollution.

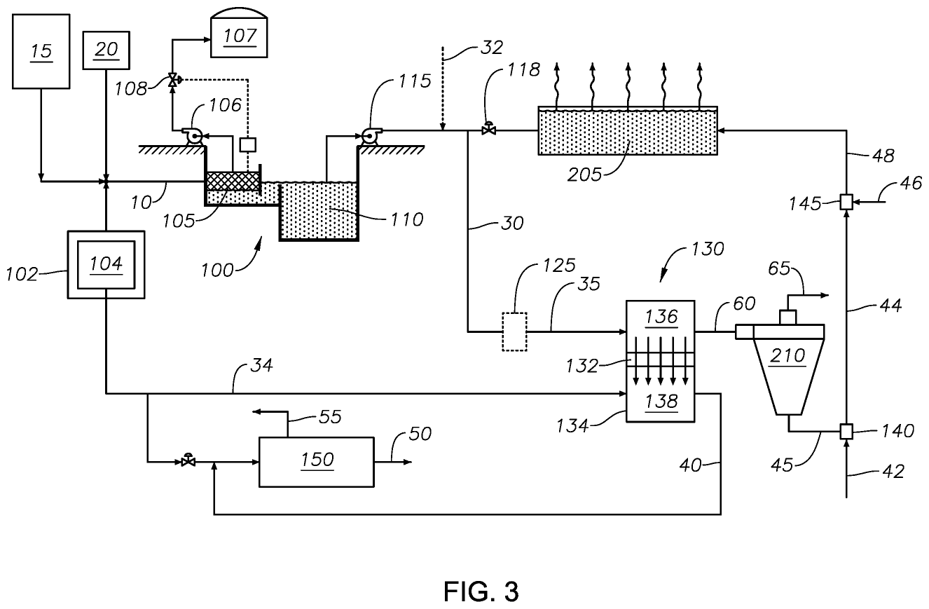

An alternate embodiment of waste water reduction system 1 and associated methods that includes evaporation pond 205 can be understood with reference to FIG. 3. Hydrocyclone 210 can be included in process when the expected oil content in the stream withdrawn from the feed side of the forward osmosis unit is greater than 100 ppmw. Hydrocyclone 210 can be installed to reduce the amount oil introduced to evaporation pond 205. Oil-containing water stream 60 is withdrawn from the feed side of the semipermeable membrane and contains water and the remaining contaminants, including an amount of oil greater than 100 ppmw. Oil-containing water stream 60 can be introduced to hydrocyclone 210. Hydrocyclone 210 can be any type of unit capable of separating oil from water. Hydrocyclone 210 can separate oil-containing water stream 60 to produce reject water stream 45 and separated oil 65.

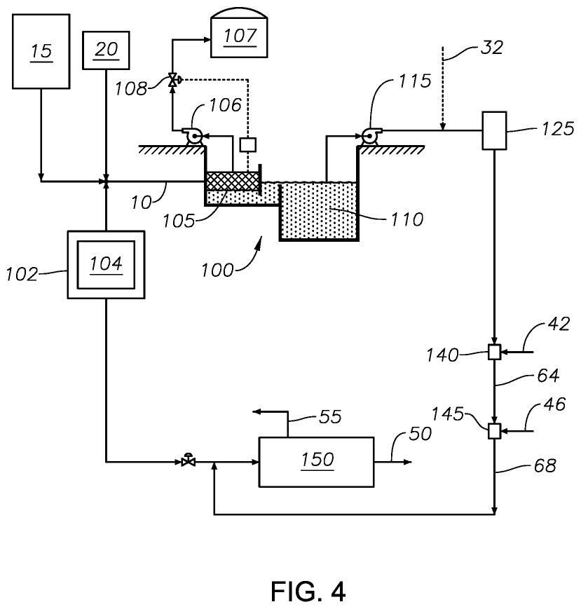

Referring to FIG. 4, an alternate embodiment of waste water reduction system 1 is described. Filtered water 35 can be introduced to oxygen mixer 140 and mixed with oxygen scavenger 42 to produce oxygen-free filtered stream 64. Oxygen-free filtered stream 64 can be mixed with chemical biocide stream 46 in biocide mixer 145 to produce treated stream 68. Treated stream 48 can be introduced to WOSEP 150. An alternate embodiment can include surface oily water tank 120 to act as a buffer tank to store excess dirty water from waste water collection pit 110 and, optionally, additional gravity sewer sumps as described with reference to FIG. 1. The addition of surface oily water tank 120 can avoid excessive flow to WOSEP 150. The embodiments of waste water reduction system 1 can eliminate the use of evaporation ponds and a forward osmosis unit.

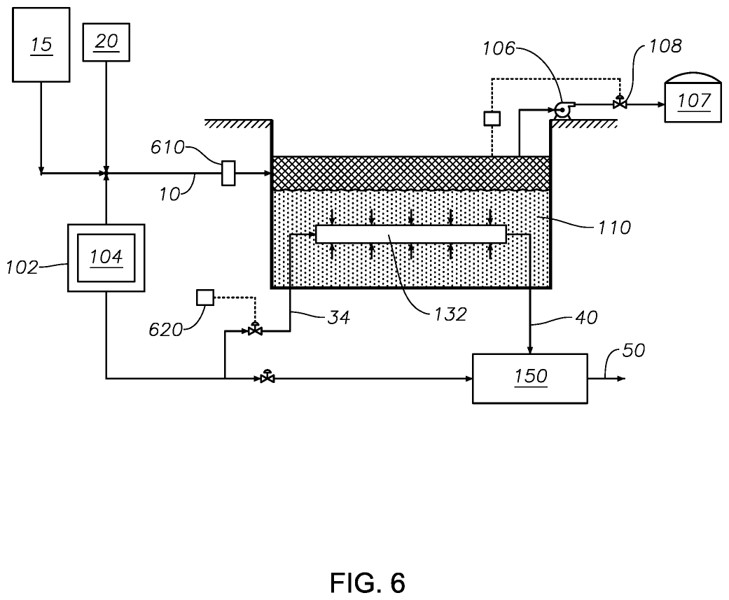

Referring to FIG. 6, an alternate embodiment of waste water reduction system 1 is described. In the embodiment described with reference to FIG. 6, semipermeable membrane 132 is positioned directly in waste water collection pit 110. Surface water 10 can be treated in treatment unit 610. Treatment unit 610 can include a filter to remove solids and can include chemical treatment to remove oxygen and reduce bacteria. Semipermeable membrane 132 is constructed to possess a feed side and a draw side. The functioning of semipermeable membrane 132 is as described with reference to FIG. 1. Piping (not shown) can be used to maintain formation water stream 34 separate from the dirty water in waste water collection pit 110 and to direct formation water stream 34 to the draw side of semipermeable membrane 132. The flow rate of formation water stream 34 can be controlled by water level controller 620. Water level controller 620 can be any type of logic controlled flow valve that can maintain the water level in waste water collection pit 110 by adjusting the flow rate of formation water stream 34. Semipermeable membrane 132 can interact directly with the dirty water in waste water collection pit 110, such that water is drawn from waste water collection pit 110 through semipermeable membrane 132 to mix with formation water stream 34 and produce diluted stream 40. Piping (not shown) can be used to maintain diluted stream 40 separate from the dirty water in waste water collection pit 110. Diluted stream 40 can be introduced to WOSEP 150. The control of the oil level is as described with reference to FIG. 1. The embodiment described with reference to FIG. 6 can be used for smaller scale waste water treatment plants that have only gravity sewer sumps and no evaporation ponds.

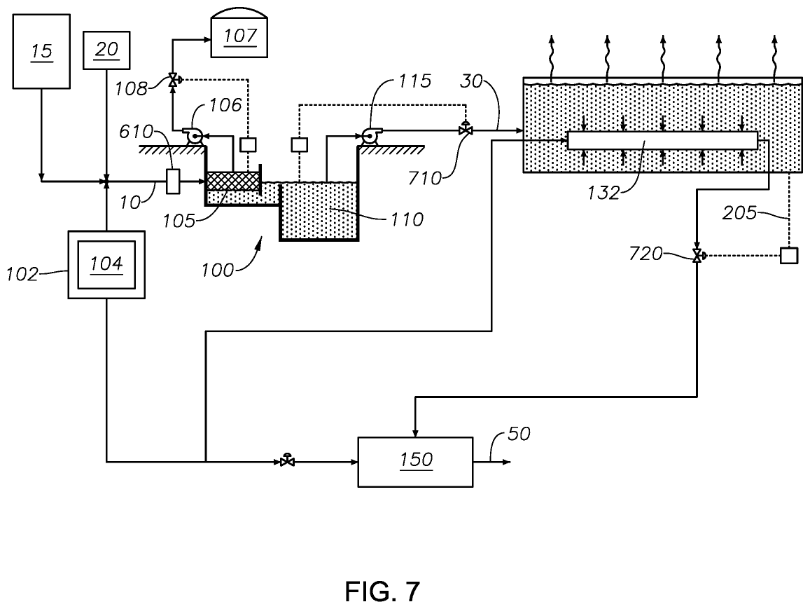

Referring to FIG. 7, an alternate embodiment of waste water reduction system 1 is provided. Semipermeable membrane 132 is positioned directly in evaporation pond 205. Surface water 30 can be introduced to evaporation pond 205. The flow rate of surface water 30 and the level in waste water collection pit 110 can be controlled by waste water level 710. Waste water level 710 can be any type of logic controlled flow valve that can maintain a water level. Piping (not shown) can be used to maintain formation water stream 34 separate from surface water in evaporation pond 205 and to direct formation water stream 34 to the draw side of semipermeable membrane 132. Semipermeable membrane 132 can interact directly with the surface water in evaporation pond 205, such that water is drawn from evaporation pond through semipermeable membrane 132 to mix with formation water stream 34 and produce diluted stream 40. Piping (not shown) can be used to maintain diluted stream 40 separate from the surface water in evaporation pond 205. Diluted stream 40 can be introduced to WOSEP 150. The flow rate of diluted stream 40 can be controlled by evaporation level controller 720. Evaporation level controller 720 can be any type of logic controlled flow valve that can maintain the water level in evaporation pond 205 by adjusting the flow rate of diluted stream 40. The control of the oil level is as described with reference to FIG. 1.

The waste water reduction system is in the absence of a desalination unit. The waste water reduction system is in the absence of a unit to desalinate produced water. The waste water reduction system is in the absence of steps to create a draw solution, the use of the formation water stream as the high concentration solution uses a readily available resource to reduce waste. The waste water reduction system is in the absence of a reverse osmosis unit.

Advantageously, the systems and methods of the waste water reduction system can integrate the GOSP produced water with open drain and evaporation ponds to extract oily rain waste water and minimize the flow of oily rain waste water to the evaporation ponds. The integrated system uses available high salinity produced water as draw solution to recover oily rain waste water, which allows such low salinity high environmental risk waste streams to be treated and disposed of underground or utilized in the production process, such as injection water for reservoir pressure maintenance. Advantageously, and unexpectedly, the waste water reduction system and methods minimize the production of the low salinity oily water collected during rain and discharged to evaporation ponds by using the high salinity produced water stream generated from desalters and production traps as draw solution in forward osmosis process. Thus, the integrated system reduces the load on the oily water system (the surface collection system), minimizes environmental pollution and provides water injection required for reservoir pressure maintenance.

Advantageously, the systems and methods of the waste water reduction system can treat surface water for disposal in the evaporation ponds without the need for specialized waste water treatment unit, such as evaporators or ion exchange units.

Although the embodiments have been described in detail, it should be understood that various changes, substitutions, and alterations can be made hereupon without departing from the principle and scope. Accordingly, the scope of the embodiments should be determined by the following claims and their appropriate legal equivalents.

The singular forms “a,” “an,” and “the” include plural referents, unless the context clearly dictates otherwise.

Optional or optionally means that the subsequently described event or circumstances can or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

As used herein and in the appended claims, the words “comprise,” “has,” and “include” and all grammatical variations thereof are each intended to have an open, non-limiting meaning that does not exclude additional elements or steps.

What is claimed is:

1. A method to reduce the generation of waste water, the method comprising the steps of:
withdrawing a formation water stream from production equipment, where the formation water stream is continuous;
introducing the formation water stream to a forward osmosis unit, where the forward osmosis unit comprises a semipermeable membrane, where the formation water stream is introduced to a draw side of the semipermeable membrane;
withdrawing a surface water feed from a waste water collection pit, where the surface water feed comprises water and contaminants, wherein the contaminants are selected from the group consisting of oil, hazardous substances, dissolved solids, bacteria, and combinations of the same;
introducing the surface water feed to the forward osmosis unit, where the surface water feed is introduced to a feed side of the semipermeable membrane, where the semipermeable membrane is configured to allow water to pass through and to prevent the contaminants from passing through;
separating the water in the surface water feed through the semipermeable membrane, where the water travels from the feed side to the draw side due to osmotic pressure;
withdrawing a diluted stream from the draw side of the semipermeable membrane; and
introducing the diluted stream to a water-oil separation plant.

2. The method of claim 1, further comprising the steps of:
withdrawing a reject water stream from the feed side of the semipermeable membrane;
mixing an oxygen scavenger stream with the reject water stream in an oxygen mixer to produce an oxygen-free stream, where the oxygen scavenger stream comprises an oxygen scavenger selected from the group consisting of sodium bisulfite, hydrazine, carbohydrazide-containing scavengers, and combinations of the same;
mixing the oxygen-free stream with a chemical biocide stream in a biocide mixer to produce a treated reject water stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same; and
introducing the treated reject water stream to the water-oil separation plant.

3. The method of claim 1, further comprising the steps of:
introducing the surface water stream to a filter, wherein the filter is configured to remove dissolved solids in the surface water stream;
filtering the surface water stream in the filter to produce a filtered stream; and
introducing the filtered stream to the forward osmosis unit.

4. The method of claim 1, further comprising the steps of:
withdrawing a reject water stream from the feed side of the semipermeable membrane;
mixing an oxygen scavenger stream with the reject water stream in an oxygen mixer to produce an oxygen-free stream, where the oxygen scavenger stream comprises an oxygen scavenger selected from the group consisting of sodium bisulfite, hydrazine, carbohydrazide-containing scavengers, and combinations of the same;
mixing the oxygen-free stream with a chemical biocide stream in a biocide mixer to produce a treated reject water stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same; and
introducing the treated reject water stream to an evaporation pond.

5. The method of claim 1, further comprising the steps of
withdrawing an oil-containing water stream from the feed side of the semipermeable membrane, wherein the oil-containing water stream comprises greater than 100 ppmw oil;
introducing the oil-containing water stream to a hydrocyclone to produce a reject water stream, where the hydrocyclone is configured to separate oil from water;
mixing an oxygen scavenger stream with the reject water stream in an oxygen mixer to produce an oxygen-free stream, where the oxygen scavenger stream comprises an oxygen scavenger selected from the group consisting of sodium bisulfite, hydrazine, carbohydrazide-containing scavengers, and combinations of the same;
mixing the oxygen-free stream with a chemical biocide stream in a biocide mixer to produce a treated reject water stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same; and
introducing the treated reject water stream to an evaporation pond.

6. The method of claim 1, where the production equipment is selected from the combination of production traps, crude tanks, desalters, and combinations of the same.

7. The method of claim 1, where the formation water stream has a salinity in the range of 50,000 to 370,000 parts-per-million (ppm) by weight.

8. The method of claim 1, where the semipermeable membrane is selected from a flat membrane, a spiral wound membrane, and a tubular membrane.

9. The method of claim 1, where the construction of semipermeable membrane is selected from the group consisting of organic materials, mineral or ceramic membranes, and combinations of the same.

10. The method of claim 1, further comprising the steps of:
separating the diluted stream in the water-oil separation plant to produce a treated produced water and recovered oil; and
injecting the treated produced water into a reservoir to maintain a pressure in the reservoir to facilitate producing hydrocarbons.

11. A system to reduce the generation of waste water, the system comprising:
production equipment configured to produce a formation water stream such that the formation water stream is continuously withdrawn from the production equipment;
a waste water collection pit configured to produce a surface water feed, where the surface water feed comprises water and contaminants, wherein the contaminants are selected from the group consisting of oil, hazardous substances, dissolved solids, bacteria, and combinations of the same;
a forward osmosis unit fluidly connected to the production equipment and the waste water collection pit, where the forward osmosis unit comprises a semipermeable membrane, where the formation water stream is introduced to a draw side of the semipermeable membrane, where the surface water feed is introduced to a feed side of the semipermeable membrane, where the semipermeable membrane is configured to allow water to pass through and to prevent the contaminants from passing through, where water in the surface water feed travels from the feed side to the draw side due to osmotic pressure; and
a water-oil separation plant fluidly connected to the forward osmosis unit, where a diluted stream from the draw side of the semipermeable membrane of the forward osmosis unit is withdrawn and introduced to the water-oil separation plant.

12. The system of claim 11, further comprising:
an oxygen mixer fluidly connected to the feed side of the semipermeable membrane, the oxygen mixer configured to mix a reject water stream from the feed side of the semipermeable membrane with an oxygen scavenger stream to produce an oxygen-free stream, where the oxygen scavenger stream comprises an oxygen scavenger selected from the group consisting of Examples of oxygen scavengers suitable for use include sodium bisulfite, hydrazine, carbohydrazide-containing scavengers, and combinations of the same; and
a biocide mixer fluidly connected to the oxygen mixer, the biocide mixer configured to mix the oxygen-free water stream with a chemical biocide stream to produce a treated reject water stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same,
wherein the treated reject water stream is introduced to the water-oil separation plant.

13. The system of claim 11, further comprising a filter fluidly connected to the waste water collection pit, the filter configured to remove dissolved solids in the surface water stream to produce a filtered stream, wherein the filtered stream is introduced to the forward osmosis unit.

14. The system of claim 11, further comprising:
an oxygen mixer fluidly connected to the feed side of the semipermeable membrane, the oxygen mixer configured to mix a reject water stream from the feed side of the semipermeable membrane with an oxygen scavenger stream to produce an oxygen-free stream, where the oxygen scavenger stream comprises an oxygen scavenger selected from the group consisting of Examples of oxygen scavengers suitable for use include sodium bisulfite, hydrazine, carbohydrazide-containing scavengers, and combinations of the same;
a biocide mixer fluidly connected to the oxygen mixer, the biocide mixer configured to mix the oxygen-free water stream with a chemical biocide stream to produce a treated reject water stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same; and
an evaporation pond fluidly connected to the biocide mixer, wherein the treated reject water stream is introduced to the evaporation pond.

15. The system of claim 11, further comprising:
a hydrocyclone fluidly connected to the feed side of the semipermeable membrane, the hydrocyclone is configured to separate oil from water to produce a reject water stream;
an oxygen mixer fluidly connected to the hydrocyclone, the oxygen mixer configured to mix the reject water stream with an oxygen scavenger stream to produce an oxygen-free stream, where the oxygen scavenger stream comprises an oxygen scavenger selected from the group consisting of Examples of oxygen scavengers suitable for use include sodium bisulfite, hydrazine, carbohydrazide-containing scavengers, and combinations of the same;
a biocide mixer fluidly connected to the oxygen mixer, the biocide mixer configured to mix the oxygen-free water stream with a chemical biocide stream to produce a treated reject water stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same; and
an evaporation pond fluidly connected to the biocide mixer, wherein the treated reject water stream is introduced to the evaporation pond.

16. The system of claim 11, where the production equipment is selected from the combination of production traps, crude tanks, desalters, and combinations of the same.

17. The system of claim 11, where the formation water stream has a salinity in the range of 50,000 to 370,000 parts-per-million (ppm) by weight.

18. The system of claim 11, where the semipermeable membrane is selected from a flat membrane, a spiral wound membrane, and a tubular membrane.

19. The system of claim 11, where the construction of semipermeable membrane is selected from the group consisting of organic materials, mineral or ceramic membranes, and combinations of the same.

20. A method to reduce the generation of waste water, the method comprising the steps of:
withdrawing a surface water feed from a waste water collection pit, where the surface water feed comprises water and contaminants, wherein the contaminants are selected from the group consisting of oil, hazardous substances, dissolved solids, bacteria, and combinations of the same;
introducing the surface water stream to a filter, wherein the filter is configured to remove dissolved solids in the surface water stream;
filtering the surface water stream in the filter to produce a filtered stream;
introducing the filtered stream to an oxygen mixer;
mixing an oxygen scavenger stream with the filtered stream in the oxygen mixer to produce an oxygen-free filtered stream, where the oxygen scavenger stream comprises an oxygen scavenger selected from the group consisting of Examples of oxygen scavengers suitable for use include sodium bisulfite, hydrazine, carbohydrazide-containing scavengers, and combinations of the same;
introducing the oxygen-free filtered stream to a biocide mixer;
mixing the oxygen-free filtered stream with a chemical biocide stream to produce a treated stream, where the chemical biocide stream comprises a chemical biocide selected from the group consisting of chlorine, glutaraldehyde, tetrakis-hydroxymethyl-phosphonium (THPS), formaldehyde, acrolein, and combinations of the same; and
introducing the treated stream to a water-oil separation plant, the water-oil separation plant configured to separate oil from the treated stream.
